(19) United States
(12) Patent Application Publication
(10) Pub. No.: US 2009/0224667 A1
(43) Pub. Date: Sep. 10, 2009

(54) Auxiliary light source and lighting system having the same

(75) Inventors: Toshitaka FUJII, Himeji-shi (JP); Atsuji NAKAGAWA, Himeji-shi (JP)

Correspondence Address: KUBOTERA & ASSOCIATES, LLC, 200 Daingerfield Road, Suite 202, Alexandria, VA, 22314, US

(73) Assignee: Phoenix Electric Co., Ltd.

(21) Appl. No.: 12/318,797

(22) Filed: Jan. 8, 2009

(30) Foreign Application Priority Data
Mar. 6, 2008 (JP) 2008-056175

(51) Int. Cl. H01J 61/00

(52) U.S. Cl. 313/567

(57) ABSTRACT

The auxiliary light source includes a vacuum chamber, a pair of electrodes, and fluorescent material. The vacuum chamber has an internal space which is evacuated. The pair of electrodes is situated inside the vacuum chamber so as to face each other. The fluorescent material is arranged inside the vacuum chamber and emits light including ultraviolet rays by receiving electrons emitted when voltage is applied between the electrodes. An arc tube of a high-pressure discharge lamp is situated within an irradiation range of the light, and the light is emitted at least from a time just before the high-pressure discharge lamp is turned on until the high-pressure lamp emits light.

### BACKGROUND OF THE INVENTION

1. Field of the Invention

The present invention relates to an auxiliary light source for lowering voltage which is necessary to start a high-pressure discharge lamp, and also relates to a lighting system including the auxiliary light source and a high-pressure discharge lamp.

2. Description of the Background Art

A high-pressure discharge lamp is mainly provided for a lighting system which is used for a liquid crystal projector and an optical device such as an exposure device. The high-pressure discharge lamp includes an arc tube which has enclosed in its internal space light-emitting material such as mercury, or halide which generates halogen cycle, or the like, and also includes a pair of main discharge electrodes which are situated inside the arc tube so as to face each other. To start the high-pressure discharge lamp, high voltage is applied between the main discharge electrodes, and discharge is caused between the main discharge electrodes by dielectric breakdown, whereby the light-emitting material is excited and emits light.

In recent years, in order to downsize a light-emitting area in a high-pressure discharge lamp so as to improve its light-emitting efficiency, an amount of light-emitting material enclosed inside an arc tube has been increased, and a capacity of an internal space of the arc tube has been decreased. As a result, a pressure inside the arc tube is extremely increased at the time of starting the high-pressure discharge lamp. The pressure there inside, according to a recently reported example, is approximately 200 atmospheres or more. Further, in the optical device, not only a reduction in an initial start (cold start) time, but also a reduction in a restart (hot start) time is required.

Particularly, the higher the pressure inside the arc tube is, the higher is the voltage which is necessary to start discharging. Accordingly, at the time of restarting (hot start) where a temperature inside the arc tube is high, a high voltage needs to be applied. In addition, restarting is delayed until the temperature of the high-pressure discharge lamp decreases to a certain extent. Further, even at the time of initial starting (cold start), a high voltage (e.g., ten-odd kV) needs to be applied.

However, problems are caused when high-voltage is applied at the time of starting the high-pressure discharge lamp. For example, dielectric breakdown is caused not only between the main discharge electrodes but also at unexpected portions (e.g., dielectric breakdown in an insulated cable coating, a creeping discharge in a connector or in a connection terminal, or the like), and consequently an electric shock is caused. In another case, due to a noise caused by application of a high-voltage, an electrical circuit mounted in the optical device malfunctions.

Then, a lighting system for starting the high-pressure discharge lamp by applying lower voltage is developed (e.g., Patent document 1: Japanese Laid-Open Patent Publication No. 2003-203605). As shown in FIG. 13, a lighting system 1 disclosed in Patent document 1 includes a high-pressure discharge lamp 2 and an auxiliary light source 3 which is formed independently of the high-pressure discharge lamp 2. The high-pressure discharge lamp 2 is composed of; an arc tube 5 which includes a light-emitting portion 5a having a light-emitting material M1 such as mercury enclosed in its internal space, and also includes a pair of sealing portions 5b for sealing the internal space of the light-emitting portion 5a; a pair of main discharge electrodes 6a situated within the light-emitting portion 5a so as to face each other; metal foils 6b which are electrically connected to the main discharge electrodes 6a and which are embedded inside the sealing portion 5b; and external lead rods 6c each having one end which is electrically connected to each of the metal foils 6b and which is embedded inside the sealing portion 5b, and also having the other end which protrudes outward from the arc tube 5.

The auxiliary light source 3 has discharge space, and discharge medium M2 is enclosed in the discharge space. When the discharge medium M2 is excited by discharge, the discharge medium M2 generates ultraviolet rays. Further, the auxiliary light source 3 has a discharge chamber 7 situated so as to be adjacent to one of the sealing portions 5b, and a starting electrode 8 situated so as to be in parallel with one of the metal foils 6b via the discharge chamber 7, the metal foil 6b being embedded inside the one of the sealing portions 5b. A conductive wire 9 for applying a high-frequency voltage between the one of the metal foils 6b and the starting electrode 8 is electrically connected to the starting electrode 8.

In order to start the high-pressure discharge lamp 2 in the lighting system 1, the high-frequency voltage is applied between the one of the metal foils 6b and the starting electrode 8. The dielectric barrier discharge is then generated between the one of the metal foils 6b and the starting electrode 8 via the discharge space of the discharge chamber 7. The discharge medium M2 in the discharge space is excited by the dielectric barrier discharge, whereby ultraviolet rays UV is generated. The ultraviolet rays UV irradiates the light-emitting material M1 enclosed in the light-emitting portion 5a in the high-pressure discharge lamp 2, whereby the light-emitting material M1 is ionized. As a result, discharge between the main discharge electrodes 6a is accelerated, whereby it is possible to start the high-pressure discharge lamp 2 by applying lower voltage.

In order to generate the dielectric barrier discharge between the metal foil 6b and the starting electrode 8, a capacitive coupling needs to be established between the one of the metal foils 6b and the starting electrode 8 via the discharge space having the discharge medium M2 enclosed therein. A high-frequency voltage (e.g., 10 kHz to 1 MHz) therefore needs to be applied between the one of the metal foils 6b and the starting electrode 8. The lighting system 1 disclosed in Patent document 1 has the following problems.

(i) A high-frequency voltage generation circuit inevitably needs to be arranged in a feeder circuit for feeding the power to the lighting system 1 so as to generate a high-frequency voltage. Particularly, even if the high-pressure discharge lamp 2 is a DC-powered high-pressure discharge lamp which does not require an AC voltage, the high-frequency voltage generation circuit needs to be arranged so as to actuate the auxiliary light source 3.
(ii) A transformer or the like having a preferable frequency characteristic is required for the high-frequency voltage generation circuit. Since such a transformer is expensive, overall costs of the feeder circuit increase.
(iii) A countermeasure against noises generated from the high-frequency voltage generation circuit is required. Such a countermeasure also increases the overall costs of the feeder circuit.

### SUMMARY OF THE INVENTION

A main object of the present invention is to provide an auxiliary light source which is capable of lowering voltage necessary to start the high-pressure discharge lamp without applying a high-frequency voltage.

A first aspect of the present invention is directed to an auxiliary light source 14. The auxiliary light source 14 includes a vacuum chamber, a pair of electrodes, and fluorescent material. The vacuum chamber has an internal space which is evacuated. The pair of electrodes is situated inside the vacuum chamber so as to face each other. The fluorescent material is filled inside the vacuum chamber and emits light including ultraviolet rays by receiving electrons emitted when voltage is applied between the electrodes. An arc tube of a high-pressure discharge lamp is situated within an irradiation range of the light, and the light is emitted at least from a time just before the high-pressure discharge lamp is turned on until the high-pressure lamp emits light.

In the auxiliary light source 14 according to the present invention, a pair of electrodes 54 is situated inside the vacuum chamber 40. Consequently, when voltage is applied between the electrodes 54 to generate an electric field between the electrodes, electrons e are easily emitted (field emission) from one electrode 54 to the other electrode 54, even if the voltage is too low to cause dielectric breakdown between the main discharge electrodes 34 in the high-pressure discharge lamp 12. By receiving the electrons e, the fluorescent material 44 filled in the vacuum chamber 40 emits light L including ultraviolet rays.

At least from just before the high-pressure discharge lamp 12 is turned on until the same emits light, the light L including the ultraviolet rays irradiates the arc tube 26 of the high-pressure discharge lamp 12, the arc tube 26 being situated within an irradiation range of the auxiliary light source 14 (at this stage the voltage is being applied between the main discharge electrodes 34). The main discharge electrodes 34 situated in the arc tube 26 receive the ultraviolet rays included in the light L. Consequently, electrons are apt to be emitted from the main discharge electrodes 34 (photo-electric effect). Otherwise, the light-emitting material 30 enclosed in the arc tube 26 is ionized by receiving the ultraviolet rays included in the light L, whereby a path (discharge route) for causing discharge between the main discharge electrodes 34 is provided. As a result, not only at the time of cold start, but also at the time of hot start, it is possible to start the high-pressure discharge lamp 12 instantaneously even with low voltage (e.g., 1.5 kV).

In other words, in the auxiliary light source 14 according to the present invention, since the voltage is applied to the electrodes 54 only so as to generate the electric field, high voltage is not required. Further, it is possible to apply low frequency AC voltage which is not capable of generating the dielectric barrier discharge (high-frequency is not necessary). Moreover, it is possible to apply a DC voltage to the electrodes 54.

The “vacuum” of the vacuum chamber 40 represents a pressure level lower than the atmospheric pressure (e.g. ≦10⁻⁵ Pa), and is not limited to an absolute vacuum. Further, the degree of the vacuum in the vacuum chamber 40 is set appropriately in accordance with a value of the voltage applied to the electrodes 54, shapes of the electrodes 54, and the like.

Preferably, in the auxiliary light source 14, an emitter may be putted on a surface of at least one of the electrodes so as to induce the electrons to be emitted easily.

Due to the function of the emitter 46, electrons e are emitted from the electrodes 54 in a lower electric field, and thus it is possible to emit the light L steadily even when low voltage is applied.

A second aspect of the present invention is directed to a lighting system 10. The lighting system 10 includes a high-pressure discharge lamp, a reflector, and the auxiliary light source. The high-pressure discharge lamp 12 includes a sealed chamber 22 which is composed of an arc tube 26 having a light-emitting material 30 enclosed in an internal space thereof, and one or two sealing portions 28 extending from the arc tube 26, and also includes a pair of main discharge electrodes 34 situated inside the arc tube 26 so as to face each other. The reflector 16 has a concave reflecting surface 58 which is situated inside the reflector 16, and a high-pressure discharge lamp fixing hole 59 which is formed at a central portion of the concave reflecting surface 58 and which has the sealing portion 28 of the high-pressure discharge lamp 12 inserted and fixed thereto. The auxiliary light source 14 is arranged at the back side of the reflector, and irradiates the arc tube via the sealing portion fixed to the high-pressure discharge lamp fixing hole 59 of the reflector 16.

In the lighting system 10 according to the present invention, the auxiliary light source 14 is arranged outside the reflector 16, that is, at the back side of the reflector 16. When the DC voltage or the low-frequency AC voltage is applied to the electrodes 54 in the auxiliary light source 14 at least during a time period from just before the high-pressure discharge lamp 12 is turned on until the same emits light, and the light L including the ultraviolet rays irradiates the arc tube 26 via the sealing portion 28 of the high-pressure discharge lamp 12, then it is possible to start/restart the high-pressure discharge lamp 12 with low voltage on the ground of the phenomena as aforementioned. Further, since the auxiliary light source 14 which is arranged at the back side of the reflector 16 does not interrupt a light path from the high-pressure discharge lamp 12, an amount of light irradiated from the lighting system 10 is not decreased.

Preferably, in the lighting system 10, the high-pressure discharge lamp 12 and the auxiliary light source 14 may be connected in parallel to each other.

As above described, the DC voltage or the low-frequency AC voltage is applied to the auxiliary light source 14, whereby it is possible to cause the light L including the ultraviolet rays to be emitted. When the lighting system 10 is configured so as to connect the auxiliary light source 14 to the high-pressure discharge lamp 12 in parallel, required is only the DC voltage or the power feeding unit 18 for supplying the low-frequency AC voltage which is necessary to start the high-pressure discharge lamp 12 and to light steadily. That is, a power feeding unit for the high-pressure discharge lamp 12 and a power feeding unit for the auxiliary light source 14 need not be provided individually.

In the auxiliary light source and the lighting system including the same according to the present invention, instead of using high voltage and high-frequency AC voltage for starting and for generating the dielectric barrier discharge, respectively, it is possible to lower the voltage which is necessary to start the high-pressure discharge lamp, and also possible to improve a start time of the high-pressure discharge lamp.

### BRIEF DESCRIPTION OF THE DRAWINGS

FIG. 1 is a diagram showing a lighting system according to the present invention;

FIG. 2 is a diagram showing a high-pressure discharge lamp according to the present invention;

FIG. 3 is a diagram showing an auxiliary light source according to the present invention;

FIG. 4 is a schematic circuit diagram showing a power feeding unit using DC voltage;

FIG. 5 is a diagram showing a procedure for manufacturing the high-pressure discharge lamp;

FIG. 6 is a diagram showing a procedure for manufacturing the auxiliary light source;

FIG. 7 is a diagram showing an auxiliary light source according to another embodiment of the present invention;

FIG. 8 is a diagram showing a single-ended auxiliary light source;

FIG. 9 is a diagram showing a lighting system in which the single-ended auxiliary light source is used.

FIG. 10 is a diagram showing an auxiliary light source according to another embodiment of the present invention;

FIG. 11 is a diagram showing an auxiliary light source according to another embodiment of the present invention;

FIG. 12 is a diagram showing an exemplary AC-powered auxiliary light source; and

FIG. 13 is a diagram showing a conventional art.

### DETAILED DESCRIPTION OF THE INVENTION

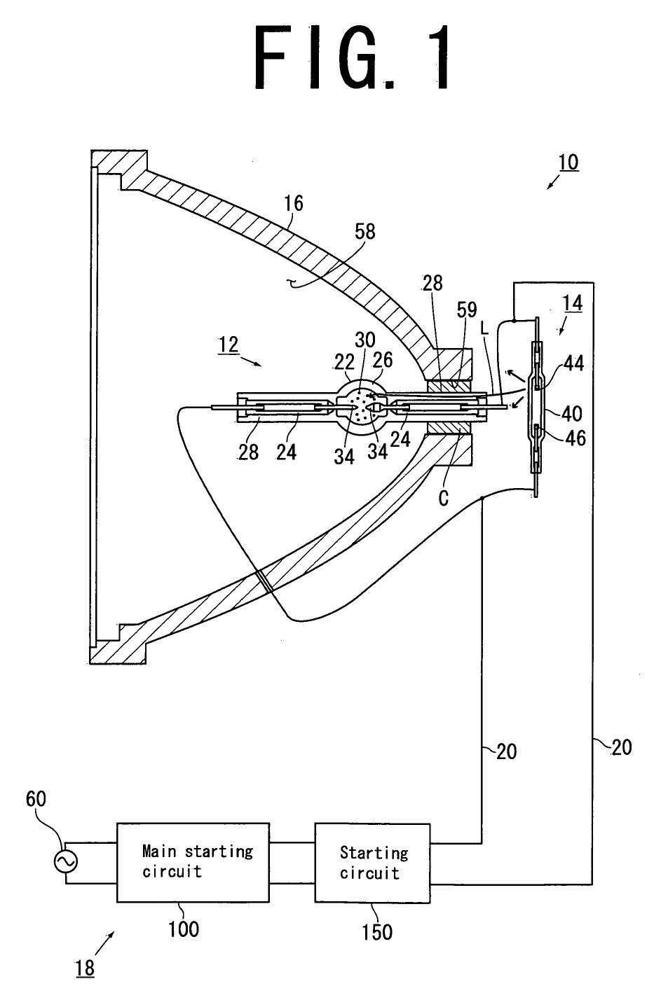

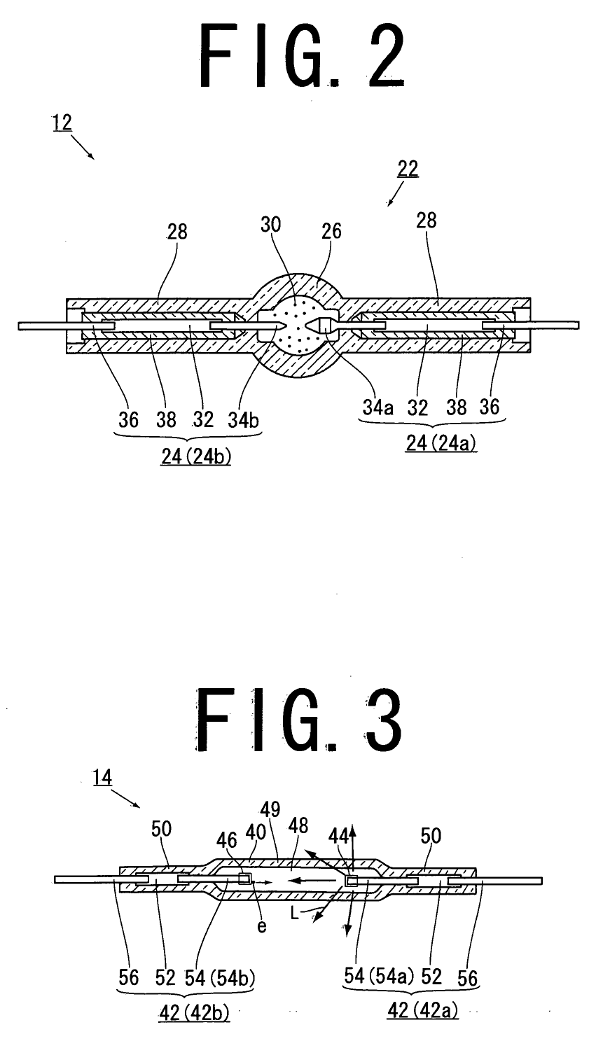

As shown in FIGS. 1 to 3, the lighting system 10 includes a high-pressure discharge lamp 12, an auxiliary light source 14, and, where necessary, a reflector 16 having the high-pressure discharge lamp 12 mounted thereto. The high-pressure discharge lamp 12 and the auxiliary light source 14 are connected to each other in parallel, and the power is fed to the high-pressure discharge lamp 12 and the auxiliary light source 14 from the power feeding unit 18 via feeders 20. The present invention may be applied to any type of the high-pressure discharge lamp, regardless of whether a single-ended type or a double-ended type, and regardless of whether a DC-powered type or an AC-powered type. Hereinafter, first embodiment where a double-ended DC-powered high-pressure discharge lamp 12 is used will be described, and then second embodiment where a double-ended type AC-powered high-pressure discharge lamp 12 is used will be described mainly regarding those points which are different from the DC-powered case.

The high-pressure discharge lamp 12 is composed of a sealed chamber 22 and a pair of main discharge mounts 24. The sealed chamber 22 is composed of an arc tube 26, which has an approximately spherical shape or a rugby-ball shape and which also has an internal space, and sealing portions 28 which extend from both sides of the arc tube 26. The sealed chamber 22 is made of silica glass which is insusceptible to thermal expansion and thermal contraction.

Enclosed in the internal space in the arc tube 26 are, light-emitting material 30 such as inert gas (including an argon gas, a xenon gas, and the like) or mercury vapor, and halide which caused halogen cycle, and the like. In the internal space, a pair of main discharge electrodes 34 (to be described later) are situated so as to be distanced from each other and so as to face each other. Voltage is applied between the main discharge electrodes 34, and discharge is caused by dielectric breakdown, whereby the light-emitting material 30 is excited and emits light.

Each of the main discharge mounts 24 includes a metal foil 32 made of molybdenum, a main discharge electrode 34 made of tungsten whose one end is situated in the internal space in the arc tube 26 and whose the other end is fixed to one end of the metal foil 32 by welding or the like, an external lead rod 36 whose one end is fixed to the other end of the metal foil 32 and whose the other end protrudes outward from the sealing portion 28, and a preseal glass 38 which is used as necessary (the preseal glass 38 being described subsequently in detail). As shown in the diagram, in the case of the DC-powered high-pressure discharge lamp 12, the anode main discharge electrode 34a is formed larger than the cathode main discharge electrode 34b.

The preseal glass 38 is a member which encloses therein the metal foil 32, a second end (a portion welded with the metal foil 32 and its adjacent portion) of the main discharge electrode 34, and one end (a portion welded with the metal foil 32 and its adjacent portion) of the external lead rod 36. The preseal glass 38 is made of the silica glass which is also used for the sealed chamber 22, and a thickness of the preseal glass 38 is thinner than that of the sealed chamber 22. An end of the preseal glass 38 at the electrode side is molded in a truncated cone shape, and the end of the truncated-cone shape is firmly shrink-sealed, when the preseal glass is welded inside the sealing portion 28 and integrated therewith.

The auxiliary light source 14 is composed of a vacuum chamber 40, an auxiliary light source mount 42, fluorescent material 44, and an emitter 46.

The vacuum chamber 40 is composed of a light-emitting portion 49 having a vacuum internal space 48, and sealing portions 50 provided at both ends of the light-emitting portion 49. As with the sealed chamber 22 of the high-pressure discharge lamp 12, the vacuum chamber 40 is molded with silica glass which is insusceptible to thermal expansion and thermal contraction. Here, the “vacuum” of the vacuum chamber 40 is not limited to an absolute vacuum representing zero pressure, but also indicates a state where a pressure level is lower than atmospheric pressure (e.g., ≦10⁻⁵ Pa).

The auxiliary light source mount 42 is molded with molybdenum, and are composed of a pair of metal foils 52 which are embedded inside the sealing portions 50 of the vacuum chamber 40, a pair of tungsten auxiliary light source electrodes 54 of cylindrical shapes (or of another shape, alternatively), which respectively have first ends situated inside the vacuum chamber 40 so as to face each other, and which also have second ends respectively fixed to one ends of the metal foils 52, a pair of external lead rods 56 which respectively have one ends fixed to the other ends of the metal foils 52 of the auxiliary light source, and which also have the other ends protruding outward from the sealing portions 50 of the auxiliary light source. A current flowing, during field emission, between the electrodes 54 of the auxiliary light source is 1 mA or less, and thus the anode electrode 54a need not be formed larger than the cathode electrode 54b even in the case where a direct current is supplied to the auxiliary light source 14.

As shown in FIG. 3, by receiving electrons e which are emitted from the auxiliary light source electrodes 54 when a voltage is applied thereto, the fluorescent material 44 emits light L including ultraviolet rays. The fluorescent material 44 is applied so as to cover a tip of the first end of the anode electrode 54a, or applied on an inside surface of the vacuum chamber 40 (particularly at a portion adjacent to the anode electrode 54a). Another embodiment will be described later.

Generally, the “fluorescent material” represents a material which efficiently emits/discharges light ranging from ultraviolet rays to infrared rays including visible rays by absorbing energy of electron beam, X-ray, ultraviolet rays, electric field and the like and by using a part of the absorbed energy. An exemplary fluorescent material is made by mixing a matrix such as halphosphate, silicate, oxide or the like with a few percent of an activator element for emitting light and by causing a chemical reaction therebetween. The fluorescent material 44 of the present embodiment is boron nitride which receives electrons e and irradiates the light L including the ultraviolet rays.

The emitter 46 is provided to the cathode electrode 54b as necessary so as to cause the electrons to be emitted easily. In the present embodiment, a pasty material including carbon nanotube as the emitter 46 is applied on a surface of the cathode electrode 54b. Consequently, a large number of projections made of the carbon nanotube can be formed on the surface of the cathode electrode 54b. Since the diameter of the carbon nanotube is extremely small (approximately 2 to 3 nm), and electric field concentration is likely to occur, it is considered to be possible to emit the electrons e from the cathode electrode 54b through the carbon nanotube when lower voltage is applied thereto.

As shown in FIG. 1, the reflector 16 is a concave shape member, accommodates the high-pressure discharge lamp 12 extending from its central portion, and causes the light generated from the arc tube 26 to be reflected forward therefrom.

A reflecting surface 58 having a concave shape is formed on an inner surface of the reflector 16, and a high-pressure discharge lamp fixing hole 59 is formed at the central portion of the reflector 16. The anode sealing portion 28 of the high-pressure discharge lamp 12 is inserted into the high-pressure discharge lamp fixing hole 59 and fixedly attached with cement C. The anode sealing portion 28 is exposed to the back side of the high-pressure discharge lamp fixing hole 59, and the auxiliary light source 14 is arranged in the vicinity of the exposed anode sealing portion 28. Consequently, the light L from the auxiliary light source 14 reaches the arc tube 26 passing through the anode sealing portion 28. Although not shown in the diagram, the auxiliary light source 14 is permeably covered with protective ceramics.

Although inexpensive borosilicate glass is used as the material of the reflector 16, various materials such as glass, metal, and aluminum silicate may be used instead thereof. As the cement C, an aluminum-silica (Al₂O₃—SiO₂) system, an aluminum (Al₂O₃) system, or a silicon carbide (SiC) system may be used.

The power feeding unit 18 is composed of an AC power supply 60 (which may be replaced with a DC power supply), a main starting circuit 100, and a starting circuit 150.

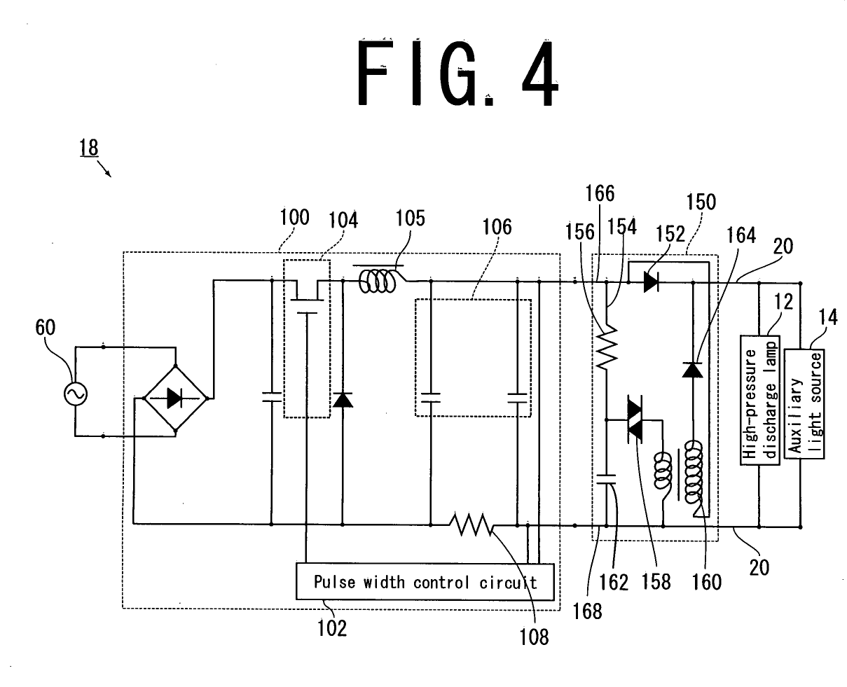

When voltage is supplied from the AC power supply 60, the main starting circuit 100 supplies a constant power, which is necessary for the high-pressure discharge lamp 12 to emit the light continuously, to the main discharge electrodes 34 of the high-pressure discharge lamp 12, in accordance with fluctuations and temporal changes in the voltage supplied to the high-pressure discharge lamp 12 and the auxiliary light source 14. As shown in FIG. 4, the main starting circuit 100 includes a pulse width control circuit 102 for outputting a pulse width control signal corresponding to a current for starting the high-pressure discharge lamp 12, an FET switching section 104 for performing a switching operation in accordance with the pulse width control signal outputted from the pulse width control circuit 102, a reactor 105 and a smoothing capacitor section 106 which smooth a switching pulse current outputted from the FET switching section 104 and which stably supply the smoothed switching pulse current to the high-pressure discharge lamp 12, and a sense resistor 108 for detecting the current for starting the high-pressure discharge lamp 12 as sense voltage.

When starting the high-pressure discharge lamp 12, the starting circuit 150 increases voltage fed from the main starting circuit 100 to a level higher than an electric field discharge is generated between the electrodes 54 of the auxiliary light source 14, but lower than dielectric breakdown is not caused between the main discharge electrodes 34. The starting circuit 15 then applies the increased voltage between the main discharge electrodes 34 of the high-pressure discharge lamp 12 and also between the electrodes 54 of the auxiliary light source 14. The starting circuit 150 includes a starting diode 152, a branch line 154, a resistor 156, a trigger element 158, a boosting transformer 160, a pulse-generating capacitor 162, and a boosted output diode 164. The starting diode 152 is connected to a positive output of the main starting circuit 100. The positive output of the main starting circuit 100 leads to a positive output line 166, and the branch line 154 branches off therefrom. The resistor 156 and the trigger element 158 are placed in the branch line 154. The branch line 154 is connected to one end of a primary side of the boosting transformer 160 via the resistor 156 and the trigger element 158. A zero voltage line 168 is connected to the other end of the primary side of the boosting transformer 160. The resistor 156 is connected to one end of the pulse-generating capacitor 162 in series. The other end of the pulse-generating capacitor 162 is connected to the zero voltage line 168 of the main starting circuit 100. One end of a secondary side of the boosting transformer 160 is connected to an output of the starting diode 152 via the boosted output diode 164. The other end of the secondary side of the boosting transformer 160 is connected to a positive input of the starting diode 152.

### (Procedure for Manufacturing High-Pressure Discharge Lamp)

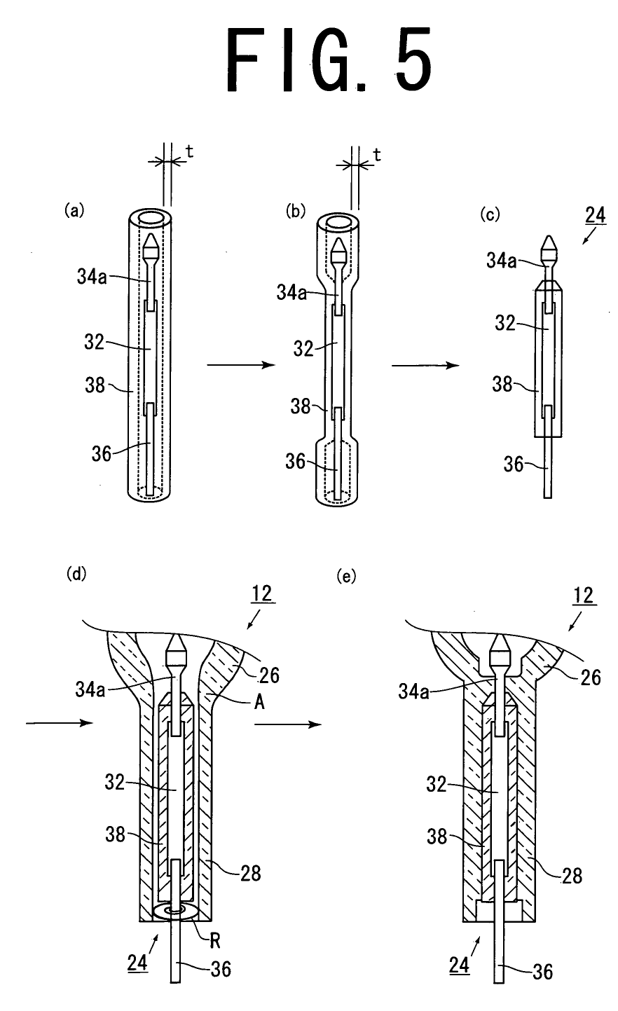

With reference to FIG. 5, an exemplary procedure for manufacturing the high-pressure discharge lamp 12 will be described. The second end of the anode main discharge electrode 34a is fixed to one end of the metal foil 32 by spot welding. One end of the external lead rod 36 is fixed to the other end of the metal foil 32 by spot welding. A serially formed structure composed of the anode main discharge electrode 34a, the metal foil 32 and the external lead rod 36 is inserted inside the preseal glass 38 having a thickness t of 0.5 to 0.8 mm (a). The preseal glass 38 is heated at 2000° C. or more (a softening point of the silica glass is about 1650° C., accordingly, the heating temperature is set to 2000° C. or more) so as to cause thermal contraction, thereby enclosing thereinside the entirety of the metal foil 32 as well as portions adjoining to its ends which respectively are welded with the anode main discharge electrode 34a at one end and with the external lead rod 36 (b) at the other end. Finally, the preseal glass 38 is cut at its predetermined portion, whereby the main discharge mount 24 is created (c). The thinner the thickness t of the preseal glass 38 is, the shorter is the heating time of the preseal glass 38. Thus, by thinning the thickness t of the preseal glass 38, it is possible to prevent the preseal glass 38 from peeling off from a surface of the metal foil 32, the peeing off being caused by a difference in the thermal contraction rate between the preseal glass 38 and the metal foil 32. The cathode side electrode 34b is also manufactured in a similar manner.

Under an argon (Ar) atmosphere, the anode main discharge mount 24 formed in the manner above is inserted into an internal space in one of the sealing portions 28 of the sealed chamber 22, the sealing portions 28 protruding from both sides of the arc tube 26 (the arc tube 26 being yet to be sealed at this stage). By utilizing resilience of a ring R temporarily engaged with the external lead rod 36 which is extracted from the main discharge mount 24, the anode main discharge mount 24 is positioned in the internal space in the one of the sealing portions 28 (d). The sealing portion 28 is then heated at 2000° C. or more for 10 to 12 seconds, for example, so as to be shrunk, whereby the preseal glass 38 on the anode side is embedded inside the sealing portion 28 (e). It is understood that in addition to the above-described shrink-sealing, pinch-sealing may be applied, in which the sealing portion 28 having been heated and softened is pinched with a mold (pincher).

After the metal foil 32 and the portions adjoining to its ends, which are included in the anode main discharge mount 24, are enclosed and embedded inside the one of the sealing portion 28, predetermined processing such as washing of the arc tube 26 is performed. Next, a light-emitting material 30 such as an inert gas or mercury vapor is introduced to fill in the internal space of the arc tube 26. In the same procedure as described above, the metal foil 32 and portions adjoining to its ends, which are included in the cathode main discharge mount 24, are enclosed and embedded inside the other one of the sealing portions 28. Then, the high-pressure discharge lamp 12 is completed.

### (Procedure for Manufacturing Auxiliary Light Source)

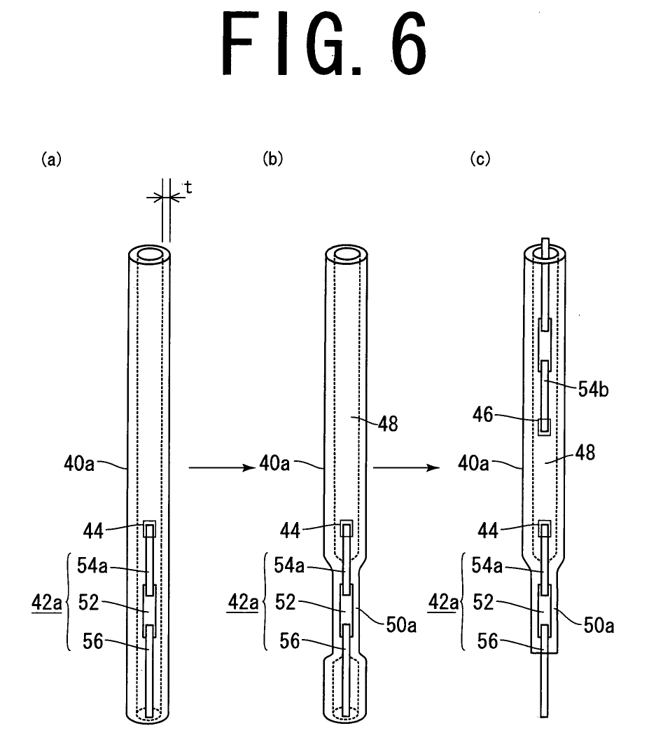

With reference to FIG. 6, an exemplary procedure for manufacturing the auxiliary light source 14 will be described. To one end of the metal foil 52, a second end of the anode electrode 54a is fixed by spot welding. The anode electrode 54a having fluorescent material 44 applied to a first end thereof in advance (or after the auxiliary light source mount 42a is manufactured). One end of the external lead rod 56 is fixed to the other end of the metal foil 52 by spot welding. Then, the anode auxiliary light source mount 42 is completed. In a similar manner, the cathode auxiliary light source mount 42b is manufactured. An emitter 46 is attached to the cathode electrode 54b in advance (or after the auxiliary light source mount 42b is manufactured).

The anode auxiliary light source mount 42a manufactured in this manner is inserted inside a silica tube 40a as the vacuum chamber 40 having a thickness t of 0.5 to 0.8 mm (a). Thereafter, under an inert atmosphere composed of an inert gas such as Ar or nitrogen, while the inert gas is flowing through the silica tube 40a, a part of the silica tube 40a, which corresponds to the metal foil 52 having been inserted in the silica tube and its adjacent portions in the anode auxiliary light source mount 42a are heated at 2000° C. or more so as to cause thermal contraction (or may be subject to pinch-sealing). Then, an anode sealing portion 50a is formed (b). The cathode auxiliary light source mount 42 including the cathode electrode 54b, which has the emitter 46 attached in advance, is prepared. A predetermined degree of vacuum is produced in the internal space 48 of the vacuum chamber 40 by using a vacuum pump or the like, and in the same manner as above described, the metal foil 52 and its adjacent portions in the cathode auxiliary light source mount 42 are enclosed and embedded inside the sealing portion 50 (c).

### (Procedure for Starting High-Pressure Discharge Lamp)

Hereinafter, a procedure for starting the high-pressure discharge lamp 12 will be described (see FIG. 4). When a switch (not shown) of the power feeding unit 18 is switched on, pulse width control is performed at the FET switching section 104 in the main starting circuit 100. An output from the FET switching section 104 is smoothed by the reactor 105 and the smoothing capacitor section 106, and then outputted to the positive output line 166. The voltage on the positive output line 166 is about 300V when the high-pressure discharge lamp 12 is started, and becomes equal to a predetermined voltage (e.g., 80V) when the high-pressure discharge lamp 12 emits light steadily.

In this manner, when the high-pressure discharge lamp 12 steadily emits light, a current outputted from the main starting circuit 100 flows along the zero voltage line 168 through the high-pressure discharge lamp 12, and causes the sense resistor 108 to generate voltage. The pulse width control circuit 102 detects the voltage across the sense resistor 108, thereby detecting a starting current flowing through the high-pressure discharge lamp 12. The pulse width control circuit 102 also detects the voltage on the positive output line 166 thereby controlling the FET switching section 104 such that a constant power is supplied to the high-pressure discharge lamp 12.

The state where the high-pressure discharge lamp 12 is steadily illuminated has been described above. Hereinafter, a state where the high-pressure discharge lamp 12 is started will be described. DC output outputted from the main starting circuit 100 flows through the positive output line 166 and the branch line 154 in a divided manner. On the branch line side, the DC output flows through the resistor 156 and charges the pulse-generating capacitor 162. When voltage of the pulse-generating capacitor 162 reaches a predetermined trigger voltage (e.g., about 100V) for the trigger element 158, the trigger element 158 is activated such that a pulse current flows through the primary side of the boosting transformer 160. Consequently, a boosted pulse current generated in the primary side steadily raises a voltage downstream of the boosted output diode 164 (to 1.2 kV, for example). The voltage is overlapped with the voltage on the positive output line 166 (about 300V), DC voltage of about 1.5 kV is applied to the high-pressure discharge lamp 12 and the auxiliary light source 14.

The dielectric breakdown between the main discharge electrodes 34 of the high-pressure discharge lamp 12 is not caused by the DC voltage only. On the other hand, the auxiliary light source 14, to which the DC voltage has been applied, has the vacuum chamber 40 which is in a vacuum state, and which has the electrodes 54 situated thereinside so as to face each other. Electric field is generated, with such low DC voltage, between the electrodes 54, whereby electrons e are emitted from the cathode electrode 54b to the anode electrode 54a via the emitter 46. By receiving the electrons e, the fluorescent material 44, which is attached to and covers the first end of the anode electrode 54a, emits the light L including the ultraviolet rays.

The light L emitted from the auxiliary light source 14 is led from one end face of the high-pressure discharge lamp 12, the end face facing the auxiliary light source 14 (and being exposed from the high-pressure discharge lamp fixing hole 59 of the reflector 16), to the arc tube 26 through the sealing portion 28 (optical fiber effect), and irradiates the light-emitting material 30 and the main discharge electrodes 34 (or either of the light-emitting material 30 and the main discharge electrodes 34) enclosed in the arc tube 26. As a result, the dielectric breakdown is caused between the main discharge electrodes 34 of the high-pressure discharge lamp 12, whereby the high-pressure discharge lamp 12 is started.

In this manner, the reason why the high-pressure discharge lamp 12 can be started only with the low DC voltage, with which it is impossible to generate the dielectric breakdown between the main discharge electrodes 34, is considered to be as follows. That is, when the light L including the ultraviolet rays irradiates the light-emitting material 30, the ultraviolet rays ionizes the light-emitting material 30, and thus a path (discharge route) for causing discharge between the main discharge electrodes 34 is formed. As a result, it is possible to start the high-pressure discharge lamp 12 even with the low voltage. Further, when the light L including the ultraviolet rays irradiates the main discharge electrodes 34, the electrons e can be emitted easily (photo-electric effect) from the main discharge electrodes 34, and the discharge between the main discharge electrodes 34 is accelerated, whereby it is possible to start the high-pressure discharge lamp 12 with the low voltage.

After the high-pressure discharge lamp 12 is started in this manner, a glow discharge is produced, and then an arc discharge is initiated. When the high-pressure discharge lamp 12 then shifts to emit light steadily, voltage of the lamp increases gradually, and returns to a predetermined level of voltage (e.g., 80V). The predetermined level of voltage is maintained thereafter. In this case, output voltage of the main starting circuit 100 is lowered inevitably, and thus a charging voltage to the pulse-generating capacitor 162 becomes equal or lower than the trigger voltage for the trigger element 158. Then, the trigger element 158 is deactivated. As a result, the starting circuit 150 is deactivated. When the voltage of the high-pressure discharge lamp 12 is lowered as above described, the electric field strength in the auxiliary light source 14 is also decreased concurrently, and thus the electrons e stop being emitted from the cathode electrode 54b. Consequently, light emission from the auxiliary light source 14 also stops automatically.

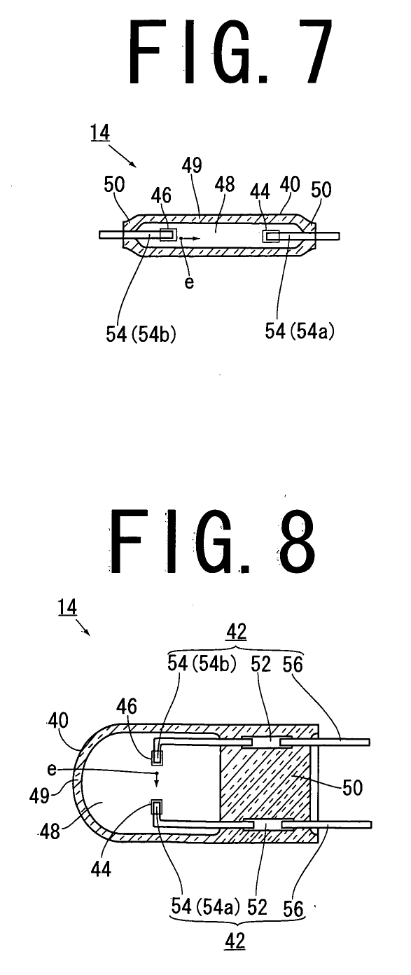

The auxiliary light source 14 is not limited to that described above. In the case where the degree of vacuum of the internal space 48 in the vacuum chamber 40 is low (i.e., close to the atmospheric pressure), and the airtightness need not be increased by using the metal foil 52, then the auxiliary light source 14 may have a configuration as shown in FIG. 7, in which the auxiliary light source mount 42 is composed of the electrodes 54 only, and both ends of the vacuum chamber 40 are shrunk respectively centering around the lengths of the electrodes 54. In this case, the vacuum chamber 40 is made of hard glass whose linear expansion coefficient is substantially the same as that of the tungsten which is used for the electrodes 54. This is to prevent lack of air-tightness in the sealing portion 50, which is caused with a large difference in the linear expansion coefficient between the vacuum chamber 40 and the electrodes 54.

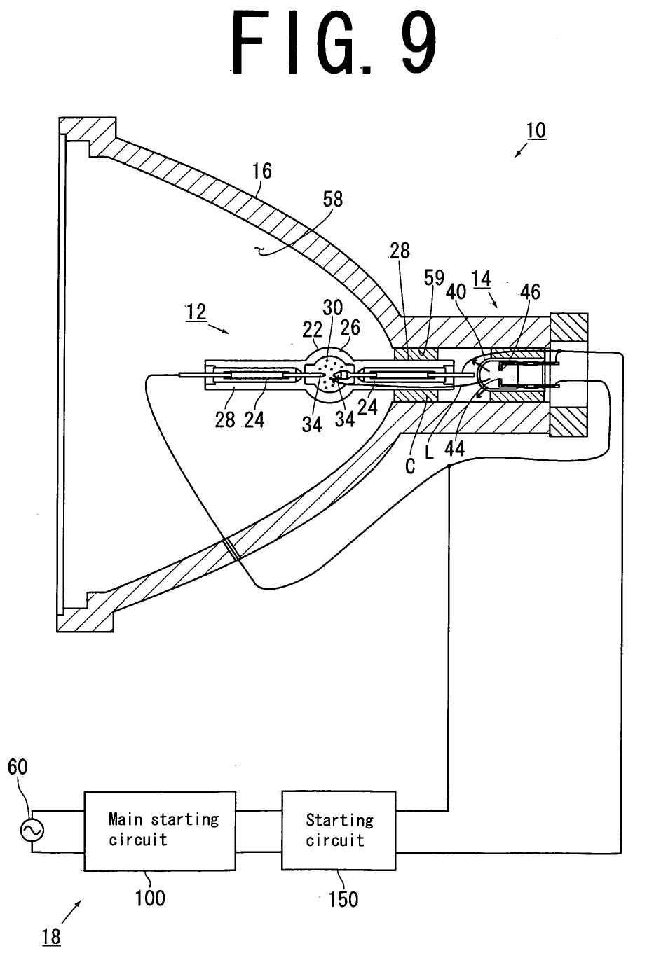

As shown in FIG. 8, the auxiliary light source 14 may be a single-ended type in which the sealing portion 50 is formed at only one side of the light-emitting portion 49 in the vacuum chamber 40. Particularly, as shown in FIG. 9, in the case of the single-ended auxiliary light source 14, the auxiliary light source 14 can be easily inserted into and fixed to the high-pressure discharge lamp fixing hole 59 of the reflector 16 such that the light-emitting portion 49 is viewed from the side of the reflecting surface 58. Thereafter, one of the sealing portions 28 of the high-pressure discharge lamp 12 is inserted from the side of the reflecting surface 58 of the reflector 16 and fixed to the high-pressure discharge lamp fixing hole 59, and wiring is arranged as necessary, whereby it is possible to form a compact lighting system 10 in which the auxiliary light source 14 is accommodated inside the high-pressure discharge lamp fixing hole 59.

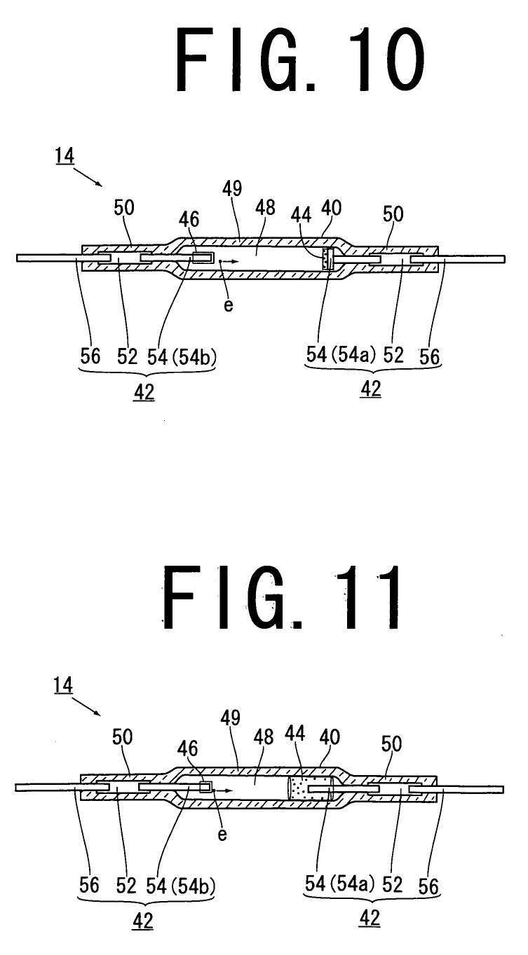

Further, as shown in FIG. 10, the auxiliary light source. 14 may have a configuration in which the first end of the anode electrode 54a is formed in a disc shape facing the cathode electrode 54b, and have fluorescent material 44 applied to a surface thereof. Further, as shown in FIG. 11, without applying the fluorescent material 44 to the anode electrode 54a, the fluorescent material 44 may be applied at an anode side portion of an interior surface of the vacuum chamber 40. The electrons e emitted from the cathode electrode 54b do not travel linearly toward the anode electrode 54a, but travel toward the anode side while drawing rather unlimited trajectories due to electric field generated between the electrodes 54. Consequently, the fluorescent material 44 applied on the interior surface of the vacuum chamber 40 is capable of receiving the electrons e. Then, the light L including the ultraviolet rays is emitted from the fluorescent material 44.

Further, the high-pressure discharge lamp 12 and the auxiliary light source 14 may be supplied by individual power feeding units, respectively. In this case, it is noted that even if the high-pressure discharge lamp 12 comes to emit light steadily, light emission from the auxiliary light source 14 does not stop automatically. Accordingly, the auxiliary light source needs to have a power feeding unit which is capable of detecting a decrease in the voltage supplied from the power feeding unit of the high-pressure discharge lamp and also capable of stopping the power supply to the auxiliary light source 14.

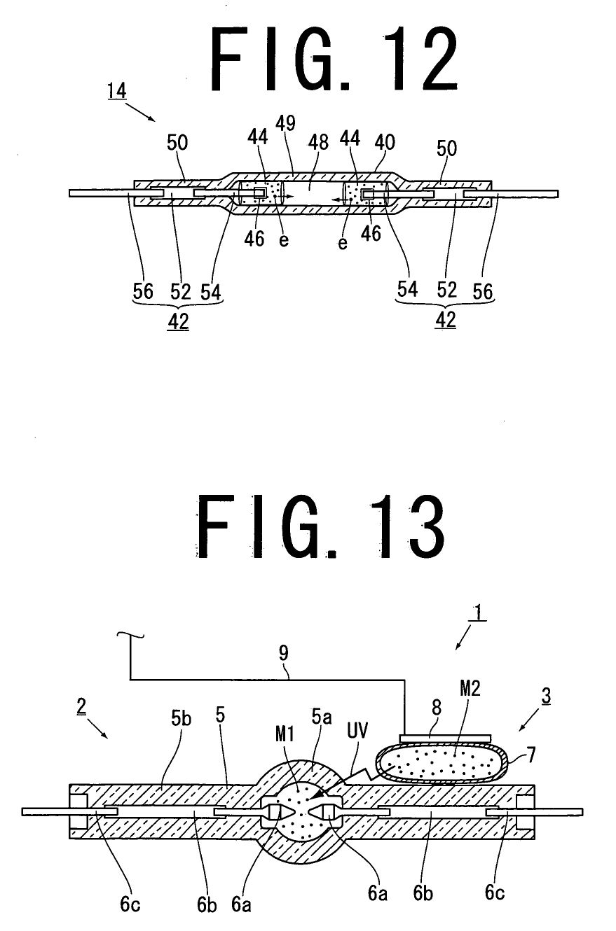

In the case of the AC-powered high-pressure discharge lamp 12, the first ends of the main discharge electrodes 34, which are situated in the arc tube 26 and which face each other, have the same shapes as each other. When the AC voltage is applied to the electrodes 54 of the auxiliary light source 14, the electrons e are emitted from and to each of the electrodes 54 in accordance with alternating current cycles. As shown in FIG. 12, the fluorescent material 44 may be arranged at both ends of the interior surface of the vacuum chamber 40 (or may be arranged on the entire interior surface of the vacuum chamber 40). With this arrangement, the electrons e are emitted from both of the electrodes 54 to the fluorescent material 44. It is possible to configure an auxiliary light source 14 which is capable of emitting the light L including the ultraviolet rays at any time in the alternating current cycles. It is understood that in the same manner as the case of the DC-powered type, the fluorescent material 44 may be applied to one of the electrodes 54. In this case, the light L is emitted, during the alternative current cycles, only when the electrons e are emitted toward the one of the electrodes 54 having the fluorescent material 44 applied thereto.

Further, the power feeding unit 18 for the AC-power is the same as that for the DC-power, except that a main starting circuit 100 which is capable of outputting an alternate current is used. The starting circuit 150 boosts the AC voltage outputted from the main starting circuit 100 such that an electric field, which causes the electrons e to be emitted from the electrodes 54 of the auxiliary light source 14, is generated. Accordingly, a high-frequency generation circuit and the like need not be provided to the power feeding unit 18.

Although the invention has been described in its preferred form with a certain degree of particularity, it is understood that the present disclosure of the preferred form has been changed in the details of construction and the combination and arrangement of parts may be resorted to without departing from the spirit and scope of the invention as hereinafter claimed.

The disclosure of Japanese Patent Application No. 2008-56175 filed Mar. 6, 2008 including specification, drawings and claims is incorporated herein by reference in its entirety.

What is claimed is:

1. An auxiliary light source comprising:
a vacuum chamber whose internal space is evacuated;
a pair of electrodes situated inside the vacuum chamber so as to face each other; and
fluorescent material filled inside the vacuum chamber, and emitting light including ultraviolet rays by receiving electrons emitted when voltage is applied between the electrodes, wherein
an arc tube of a high-pressure discharge lamp is situated within an irradiation range of the light, and the light is emitted at least from a time just before the high-pressure discharge lamp is turned on until the high-pressure discharge lamp emits light.

2. The auxiliary light source according to claim 1, further comprising an emitter is putted on a surface of at least one of the electrodes so as to induce the electrons to be emitted easily.

3. A lighting system comprising a high-pressure discharge lamp, a reflector and the auxiliary light source according to claim 1;
the high-pressure discharge lamp including:
a sealed chamber which contains an arc tube having light-emitting material enclosed in an internal space thereof and one or two sealing portions extending from the arc tube; and
a pair of main discharge electrodes situated inside the arc tube so as to face each other;
the reflector including:
a concave reflecting surface situated thereinside; and
a high-pressure discharge lamp fixing hole formed at a central portion of the concave reflecting surface, and which has the sealing portion of the high-pressure discharge lamp inserted and fixed thereto; and
wherein the auxiliary light source is arranged at a back side of the reflector, and which irradiates the arc tube via the sealing portion fixed to the high-pressure discharge lamp fixing hole of the reflector.

4. A lighting system comprising a high-pressure discharge lamp, a reflector and the auxiliary light source according to claim 2;
the high-pressure discharge lamp including:
a sealed chamber which contains an arc tube having light-emitting material enclosed in an internal space thereof and one or two sealing portions extending from the arc tube; and
a pair of main discharge electrodes situated inside the arc tube so as to face each other;
the reflector including:
a concave reflecting surface situated thereinside; and
a high-pressure discharge lamp fixing hole formed at a central portion of the concave reflecting surface, and which has the sealing portion of the high-pressure discharge lamp inserted and fixed thereto; and
wherein the auxiliary light source is arranged at a back side of the reflector, and which irradiates the arc tube via the sealing portion fixed to the high-pressure discharge lamp fixing hole of the reflector.

5. The lighting system according to claim 3, wherein the high-pressure discharge lamp and the auxiliary light source are connected in parallel to each other.

6. The lighting system according to claim 4, wherein the high-pressure discharge lamp and the auxiliary light source are connected in parallel to each other.
